(19) United States
(12) Patent Application Publication
(10) Pub. No.: US 2004/0018399 A1
(43) Pub. Date: Jan. 29, 2004

(54) Method and system for controlling fuel-cell power for fuel-cell hybrid electric vehicle

(76) Inventor: Jin-Hwan Jung, Seongnam-city (KR)

Correspondence Address: Pennie & Edmonds, LLP, 3300 Hillview Avenue, Palo Alto, CA, 94304, US

(21) Appl. No.: 10/391,638

(22) Filed: Mar. 18, 2003

(30) Foreign Application Priority Data
Jul. 23, 2002 (KR) 2002-0043297

(51) Int. Cl. H01M 16/00; H01M 8/04; H02J 7/00; B60L 11/18

(52) U.S. Cl. 429/9; 429/22; 320/101; 180/65.3

(57) ABSTRACT

A fuel-cell power control method for a fuel-cell hybrid electric vehicle is provided, which comprises determining a target fuel-cell power based on motor power demand and a state of charge of a battery. Furthermore, the method comprises determining a target fuel-cell voltage responding to the target fuel-cell power and controlling a voltage of a fuel-cell to be the target fuel-cell voltage.

### FIELD OF THE INVENTION

Generally, the present invention relates to a method and system for controlling the power output from a fuel-cell of a fuel-cell hybrid electric vehicle. More particularly the present invention relates to a method and system that increases the overall energy efficiency of a fuel-cell hybrid electric vehicle while allowing the vehicle to rapidly respond to changes in power demand.

### BACKGROUND OF THE INVENTION

A fuel-cell hybrid electric vehicle is a kind of series-type fuel-cell hybrid electric vehicle. The typical fuel-cell hybrid electric vehicle includes a fuel-cell and a battery as an electric energy source that provides electric energy to a driving motor. Also typically included is a DC conversion device, such as, a bi-directional DC/DC converter, for controlling the operation of the battery. Further included is an inverter for converting the DC current into AC current and for providing the same to the driving motor. Each component has respective control units that are connected to each other through a communication line that relays various information.

Typically, the fuel-cell hybrid electric vehicle operates in various operating modes in response to operation of the battery and the fuel-cell. However, energy efficiency of the traditional fuel-cell hybrid electric vehicle is less than that of a traditional electric vehicle alone or a traditional fuel-cell vehicle alone.

Therefore, it would be advantageous to increase the energy efficiency of the fuel-cell hybrid electric vehicle and to efficiently generate power that is required to drive the vehicle when it is demanded by the driver.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In a preferred embodiment of the present invention, a fuel-cell power control method for a fuel-cell hybrid electric vehicle comprises determining a target fuel-cell power based on motor power demand and the state of charge of the battery, determining a target fuel-cell voltage in response to the target fuel-cell power, and controlling the voltage of the fuel-cell to be the target fuel-cell voltage.

It is preferable that the determination of a target fuel-cell voltage is based on predetermined power-voltage relationships of the fuel-cell. It is also preferable that controlling the voltage of the fuel-cell comprises determining a target battery current such that a current fuel-cell voltage becomes the target fuel-cell voltage, determining a target inductor voltage such that a battery current becomes the target battery current, and controlling an inductor voltage to be the target inductor voltage such that a battery current becomes the target battery current.

In another preferred embodiment of the present invention, the fuel-cell power control system for a fuel-cell hybrid electric vehicle that includes a fuel-cell and a battery as electric energy sources comprises a DC/DC converter and a control unit. The DC/DC converter is electrically coupled to the battery and configured to control a battery current and a battery voltage. The control unit is coupled to the DC/DC converter and is programmed to execute a control method which comprises determining a target fuel-cell power based on motor power demand and the state of charge of the battery. The control method also includes the step of determining a target fuel-cell voltage in response to the target fuel-cell power and controlling the voltage of the fuel-cell to be the target fuel-cell voltage.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a block diagram showing a power system of a fuel-cell hybrid electric vehicle according to the present invention;

FIG. 2 is a block diagram illustrating energy flow in the power system of FIG. 1;

FIG. 3 is a flowchart showing a power control method for a fuel-cell hybrid electric vehicle according to an embodiment of the present invention;

FIG. 4 is a block diagram illustrating current flows and output voltage of a fuel-cell of FIG. 1;

FIG. 5 is a block diagram for power control according to an embodiment of the present invention; and

FIG. 6 is a block diagram for control of an output voltage of a fuel-cell in the power control of FIG. 5.

### DETAILED DESCRIPTION OF THE INVENTION

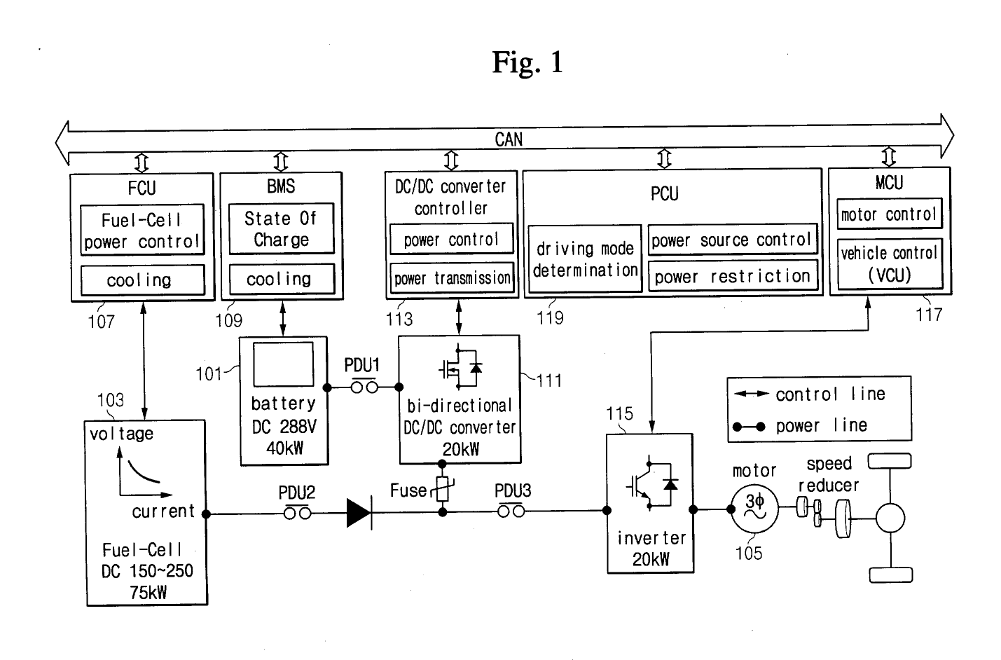

According to FIG. 1, a power system 100 of a fuel-cell hybrid electric vehicle generates a driving force by driving a motor 105 by electric energy of a battery 101 or/and a fuel-cell 103. The fuel-cell 103 outputs DC electric voltage. A fuel-cell control unit (FCU) 107 controls the output power and cooling of the fuel-cell 103. A battery management system (BMS) 109 controls a state of charge (SOC) and cooling of the battery 101.

A bi-directional DC/DC converter 111 is controlled by a DC/DC converter control unit 113. The DC/DC converter control unit 113 controls the charging and discharging the battery 101.

An inverter 115 receives AC electric voltage from the battery 101 and the fuel-cell 103, and converts the AC voltage to DC voltage. The DC voltage is then transmitted to the driving motor 105. The inverter 115 is controlled by a motor control unit (MCU) 117.

The FCU 107, BMS 109, DC/DC converter control unit 113, and the MCU 117 are connected to each other through a controller area network (CAN). These components receive a control signal from a power control unit (PCU, which is an upper control unit) 119. The PCU 119 determines a driving mode, and controls power source and power restriction.

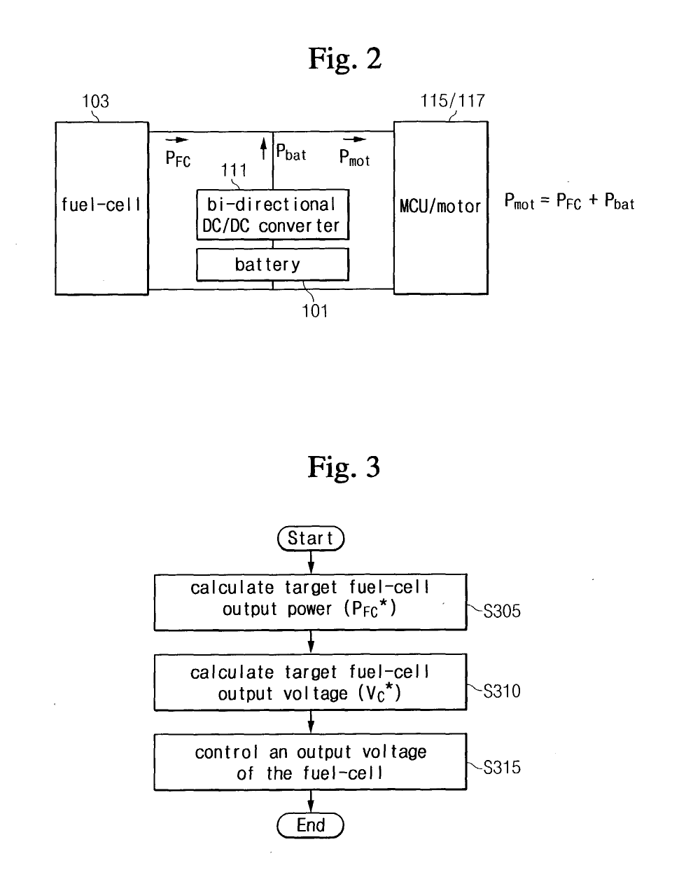

As shown in FIG. 2, motor power Pₘₒₜ is equal to a sum of the fuel-cell power P_{FC} and battery power P_{bat}. A driving mode is determined according to the fuel-cell power and the battery power. If the battery power is greater than 0, the driving mode is a battery discharge mode, and if the battery power is less than 0, the driving mode is a battery charge mode. If the fuel-cell power is equal to the motor power (that is, if the battery power is equal to 0), the driving mode is a fuel-cell mode, and if the battery power is equal to the motor power (that is, if the fuel-cell power is equal to 0), the driving mode is an electric vehicle mode.

The power control unit 119 and other control units preferably include a processor, a memory, and other necessary hardware and software components as will be understood by persons skilled in the art, to permit them to execute the control function as described hereinafter.

FIG. 3 shows a preferred embodiment of the power control method according to the present invention. The power control unit 119 calculates target fuel-cell output power P_{FC}* in step S305. The target fuel-cell output power P_{FC}* is preferably calculated based on demanded motor power Pₘₒₜ and the state of charge of the battery. The power control unit 119 then calculates target fuel-cell output voltage V_{C}* using a power-voltage relationship of the fuel-cell 103 in step S310. The power control unit 119 performs voltage control, through control of the bi-directional DC/DC converter 111, such that the output voltage of the fuel-cell 103 becomes the target fuel-cell output voltage V_{C}* in step S315.

The output power of the fuel-cell 103 becomes the calculated output power. At this time, the battery power is defined as a difference between the motor power and the fuel-cell power.

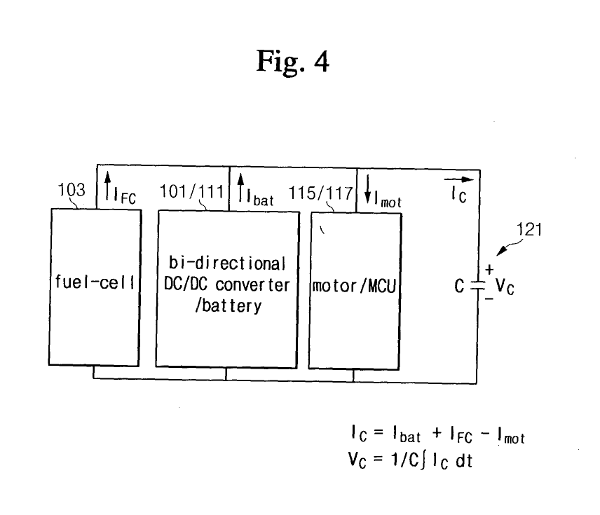

As shown in FIG. 4, a capacitor C 121 is connected in parallel to the fuel-cell 103. Fuel-cell current I_{FC} and battery current I_{bat} are divided into a motor current Iₘₒₜ and a capacitor current I_{C.}

Therefore, the following relationships exist.

I_{C}=I_{bat}+I_{FC}−Iₘₒₜ

V_{C}=1/C∫I_{C}dt=1/C∫(I_{bat}+I_{FC}−Iₘₒₜ)dt,

where V_{C} is a voltage across both terminals of the capacitor C 121.

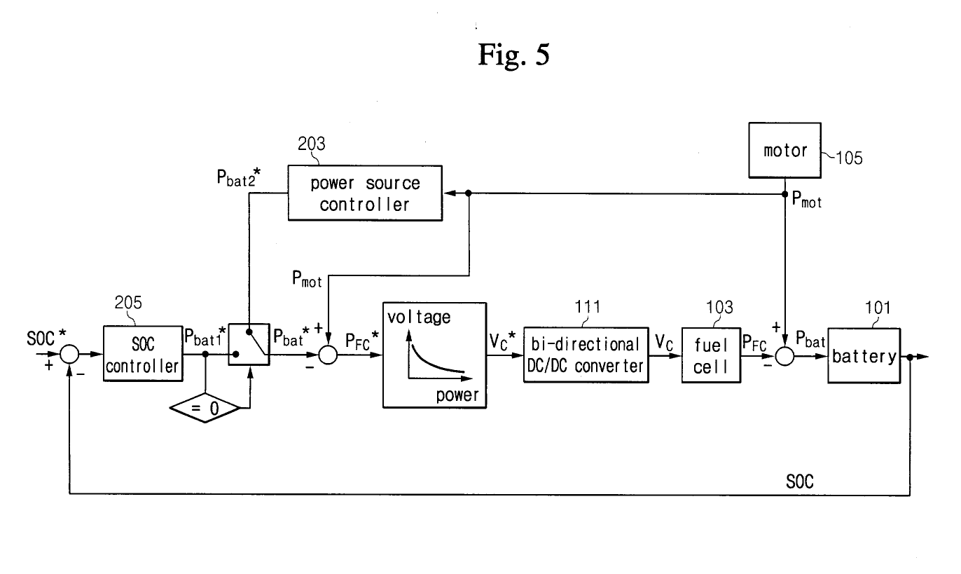

Referring next to FIG. 5, the power control unit 119 preferably includes a power source controller 203 and a SOC controller 205. The power source controller 203 calculates a basic battery power P_{bat2}* based on motor power Pₘₒₜ demand from the driver. The SOC controller 205 determines whether a current SOC is within a predetermined range (for example, 50˜70%). If the current SOC is within the predetermined range, a target battery output power P_{bat} * is set as the basic battery power P_{bat2}*. However, if the current SOC is not within the predetermined range, the target battery output power P_{bat}* is set as a predetermined battery power P_{bat1}*. The battery power P_{bat1}* is a value for maintaining the SOC of the battery within the predetermined range.

After calculating the target battery output power P_{bat}*, the power control unit 119 calculates a target fuel-cell power P_{FC}* using the target battery power P_{bat}* and the demanded motor power Pₘₒₜ. Here, the target fuel-cell power P_{FC}* is determined as a difference between the demanded motor power Pₘₒₜ and the target battery power P_{bat}*. The power control unit 119 then calculates a target fuel-cell voltage V_{C}* using the target fuel-cell power P_{FC}* and a table including power-voltage relationships of the fuel-cell 103. The values included in the table are preferably determined through experiments. The power control unit 119 then controls the bi-directional DC/DC converter 111 such that a voltage of the fuel-cell 103 becomes the target fuel-cell voltage V_{C}*.

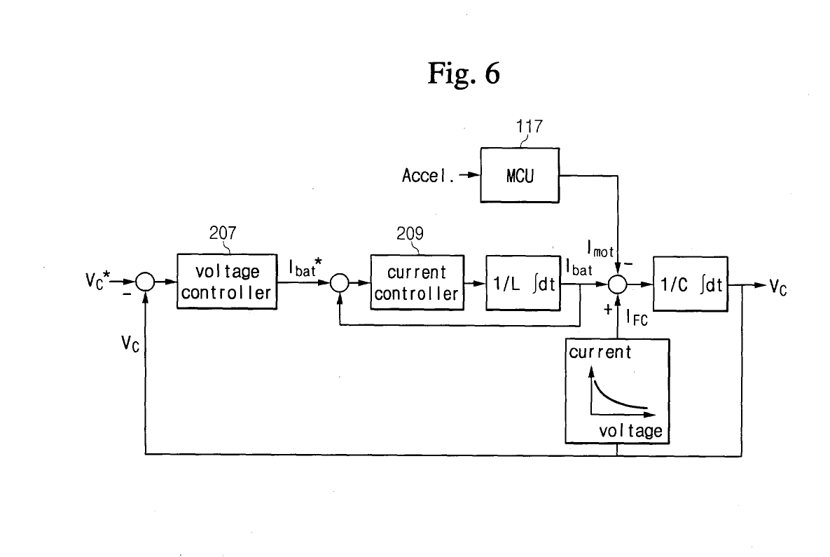

Referring to FIG. 6, control of the fuel-cell voltage through the bi-directional DC/DC converter 111 will be explained. A voltage controller 207 generates a target battery current I_{bat}* in proportion to a difference between the target fuel-cell voltage V_{C}* and a current fuel-cell voltage V_{C}. In other words, the voltage controller 207 determines the target battery current I_{bat}* as a value where the fuel-cell voltage V_{C} becomes the target fuel-cell voltage V_{C}*.

A current controller 209 is also provided in order for the battery current I_{bat} to be the target current I_{bat}*. That is, the current controller 209 controls the current of the battery 101, and the current of the battery 101 is regulated through control of current passing through an inductor L inside the bi-directional DC/DC converter 111. The current controller 209 determines a target voltage across the inductor L inside the bi-directional DC/DC converter 111 such that the battery current I_{bat} becomes the target battery current I_{bat}*.

Therefore, as shown in FIG. 4, the current passing through the capacitor C 121 and the voltage across the capacitor C 121 become as follows:

I_{C}=I_{bat}+I_{FC}−Iₘₒₜ

V_{C}=1/C∫I_{C}dt=1/C∫(I_{bat}+I_{FC}−Iₘₒₜ)dt

Consequently, the fuel-cell voltage V_{C} becomes the target fuel-cell voltage V_{C}*, and the fuel-cell power P_{FC} becomes the target fuel-cell power P_{FC}*, as shown in FIG. 5.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. A fuel-cell power control method for a fuel-cell hybrid electric vehicle, comprising:
determining a target fuel-cell power based on motor power demand and a state of charge of a battery;
determining a target fuel-cell voltage responding to said target fuel-cell power; and
controlling a voltage of a fuel-cell to be said target fuel-cell voltage.

2. The fuel-cell power control method of claim 1, wherein said determining a target fuel-cell voltage is based on predetermined power-voltage relationships of said fuel-cell.

3. The fuel-cell power control method of claim 1, wherein said controlling a voltage of a fuel-cell comprises:
determining a target battery current such that a current fuel-cell voltage becomes said target fuel-cell voltage;
determining a target inductor voltage such that a battery current becomes said target battery current; and
controlling an inductor voltage to be said target inductor voltage such that a battery current becomes said target battery current.

4. A fuel-cell power control system for a fuel-cell hybrid electric vehicle including a fuel-cell and a battery as electric energy sources, comprising:
a DC/DC converter electrically coupled to said battery, and configured to control a battery current and a battery voltage; and
a control unit coupled to said DC/DC converter, said control unit being programmed to execute a control method comprising:
determining a target fuel-cell power based on motor power demand and a state of charge of said battery;
determining a target fuel-cell voltage responding to said target fuel-cell power; and
controlling a voltage of said fuel-cell to be said target fuel-cell voltage.

5. The fuel-cell power control system of claim 4, wherein said determining a target fuel-cell voltage is performed based on predetermined power-voltage relationships of said fuel-cell.

6. The fuel-cell power control system of claim 4, wherein said controlling a voltage of a fuel-cell comprises:
determining a target battery current such that a current fuel-cell voltage becomes said target fuel-cell voltage;
determining a target inductor voltage such that a battery current becomes said target battery current; and
controlling an inductor voltage to be said target inductor voltage such that a battery current becomes said target battery current.
